(19) United States
(12) Patent Application Publication
(10) Pub. No.: US 2008/0313222 A1
(43) Pub. Date: Dec. 18, 2008

(54) Apparatus and Method For Visually Generating a Playlist

(75) Inventors: Fabio Vignoli, Veldhoven (NL); Rob Van Gulik, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,104

(22) PCT Filed: Oct. 5, 2005
(86) PCT No.: PCT/IB2005/053278

§ 371 Date: Apr. 12, 2007

Related U.S. Application Data
(60) Provisional application No. 60/618,929, filed on Oct. 14, 2004.

(51) Int. Cl. G06F 17/30

(52) U.S. Cl. 707/104.1; 707/E17.009

(57) ABSTRACT

An apparatus and method for dynamically generating a playlist to a user are provided. An on-screen user interface display is used for generating a display of a sequence of media desired by a user, in which an artist map having a large collection of music is displayed so that a user can selectively create a playlist path to generate the playlist according to a configuration of attribute values that corresponds to a specified position selected by a user on the artist map within the display. The artist map may include an overview of a large music collection based on the sound of music in such a way that similar artists are placed close together and provides at least one of the following: artist, album, style, mood, genre, tempo, and year of music.

The present invention relates to an apparatus and method for providing a playlist of media to users of music players.

Digital consumer electronic devices have made it possible to store a large amount of content on small portable devices. The trends of miniaturization and increasing storage capacity for portable music players lead to problems of navigation and complex user-interactive tasks to operate. The current available user interfaces typically use a folder-based structure, which limits the user to find desired items as the user is confronted with an enormous amount of digital music. Innovations such as the iPod touch-wheel or super-scroll on the HDD100 are focused on improving the navigation in a list-based hierarchical setting. However, improving the easy use of this type of interface may not be adequate since finding items in the increasingly long lists is hard and takes a lot of time. Further, creating playlists is currently done off-site and therefore time-consuming.

Accordingly, there is a need for means to create a playlist when using portable music players that are both fast and easy with as little interaction as possible, while meeting the users' demands even in a large music collection and on a small screen.

The present invention provides a system and method for dynamically generating playlists of media in accordance with the user's preferences. The system includes an on-screen user interface display that generates a display of an artist map representing a large collection of music. The artist map may include both year and tempo magnets (or other attribute magnets), resulting in an artists clustering that clearly separates the groups of slow, medium and fast music and may also include different colors to reflect different tempos of music. A user's ability to navigate a large collection of media is improved by creating a playlist link on the artist map by clicking on certain regions of the artist in sequence. The playlist link path corresponds to the media desired by a user and is generated based on a configuration of attribute values that corresponds to the specified position selected by a user on the artist map.

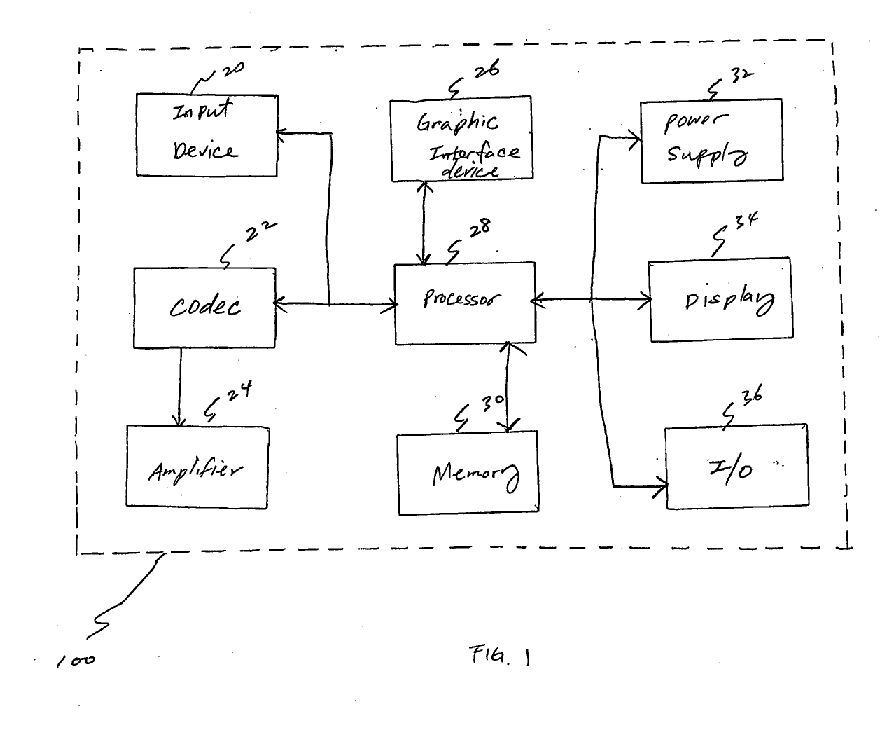

FIG. 1 shows a simplified block diagram of a portable audio system according to the invention.

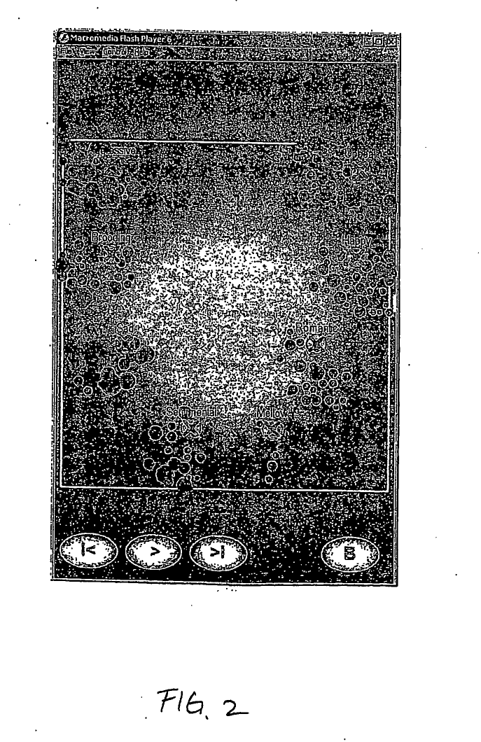

FIGS. 2(a) and (b) show an on-screen user interface display illustrating an artist map according to the invention.

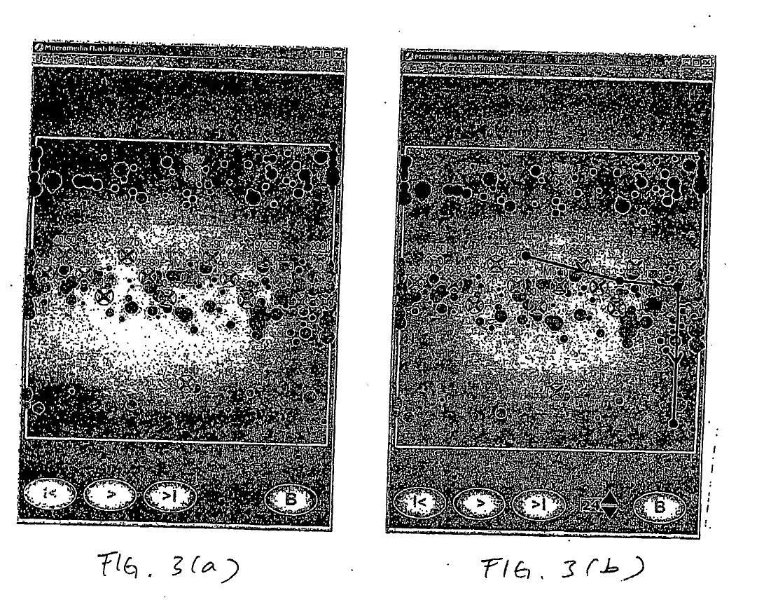

FIG. 3 shows an on-screen user interface display illustrating an artist map indicating a navigation path according to the invention.

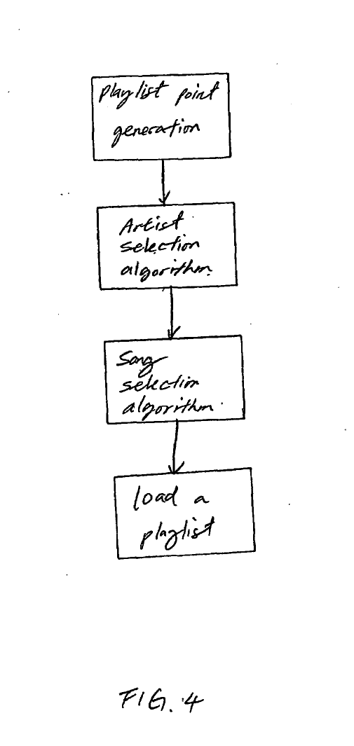

FIG. 4 illustrates a flow chart for creating a playlist according to the invention.

Referring to FIG. 1, an exemplary portable audio system 100 providing an on-screen user interface display according to the invention includes an input device 20, a coder/decoder (CODEC) 20, an amplifier 24, a graphic interface device 26, a processor 28, a memory 30, a power supply 32, a display 34, and an I/O interface 36.

The input device 20 may be implemented using a touch-sensitive display and/or electro-mechanical switches that are known in the art. The codec 22 converts a digital data stream to an analog signal. Those skilled in the art will appreciate that the codec 22 may be implemented using any of the known CODEC technologies for either speech applications, music applications, or both. The analog amplifier 24 amplifies the converted analog data from the codec 22 to an external audio output device, such as headphones.

The processor 28 may be implemented using any conventional processor, such as a microprocessor, embedded controller, digital signal processor (DSP), a central processing nit (CPU) or the like. The memory 30 may include both random access memory (RAM) and read-only memory (ROM) and further includes a basic input-output system (BIOS), which contains instructions that allow the processor to communicate with various peripheral devices. The power supply provides power to all the components of the system 100 and may comprise a plurality of AAA batteries. The power supply 36 may also include an external power supply to supply a regulated voltage. The display 34 may be implemented as a liquid crystal display (LCD) and may include a touch-screen of about 4 inches, which would fit nicely on the front of a current portable music player. However, it is not limited to a small display and the method described herein can be applied to generate a playlist in any displayable devices. The I/O interface 36 may be a serial interface and/or a universal serial bus (USB) interface.

It should be noted that although the system 100 is described in the context of a system for operating a consumer electronics device, this is exemplary only. The principles of the invention may be applied in user interface systems for operating other, non-consumer electronics apparatuses and for operating Application programs on Personal Computers (PCs) or other devices, for example.

In operation, the processor 28 provides an artist map to the display 34 according to a set of interactive, hierarchical, level-of-control, playlist menu displays in order to assist users to find the music they like to hear. These menu displays include, for example, the displays shown in FIGS. 2-3 so that a playlist can be generated with a minimum interaction by users for a subsequent play through navigating the menus. The processor 28 in conjunction with the display 34 displays the playlist in response to both menu-item selection and navigation commands.

Now, a description will be made in detail in regards to this invention with reference to FIGS. 2-4.

The inventors have realized that similarities among songs and artists, with respect to music style, mood, and tempo are some of the most important attributes to help users find the music they like to hear. A new graphical user interface according to the present invention was developed so that the user can search for specific items as well as for general music (or a non-specific search). The specific items are searched by genre, artist, album, and song; users can conduct specific searches; and non-specific searches are accomplished using a “similar artist map.”

In the similar artist map, artists are positioned based on the sound of their music in such a way that similar artists are placed close together, so that clusters of similar artists are close to “attribute magnets” that have a high correlation with the kind of music they make. The set of “attribute magnets” consists of mood, genre, type, and year magnets which reflect the attributes style, mood, and tempo of the artists. Thus, “attribute magnets” are labeled to clarify what kind of music they attract, and, to provide more context, artists may be colored differently to indicate different attribute information. That is, the user may decide to have the artists clustered around mood magnets and cluster different tempo of music indicated by different color.

An illustrative example of positing of the magnets with different criteria is shown in the following table.

As shown, two types of magnets can be displayed: i.e., from left to right would represents year and from bottom to top would represents tempo of the music. Also, a circular magnets can be used to represent different genres.

FIG. 2 shows an example of an artist map using mood magnets and coloring to indicate different tempo information. As shown, an overview of a large music collection is divided into a plurality of different music relating to different moods, for the user is provided in the artist map. The user can navigate the music collection to select a subset of the music by zooming in a desired region of the artist map. The user can zoom in on the happy music by clicking on the happy music region for example, then use other types of magnets, i.e. year, to cluster this subset further. Thus, after selecting the happy music and seeing only happy music, the user can now use a hierarchical browser to select a more specifically desired artist or music. In this example different colors in the happy music also represent different tempos. Accordingly, based on the mood magnets the user could generate a playlist that spans from aggressive to mellow music. At the same time, the user also has a choice of selecting different tempos of music within the group of happy music by selecting region indicated by different color. As a result, a minimal interaction is required, and the user chooses his or her level of control to generate the playlists.

FIG. 3 shows another example of an on-screen user interface display indicating an artist map and a navigation path identified by a bold arrow highlighting, which enables a user to readily see the navigation path and play sequence. In particular, an artist map shown in FIG. 3(a) may be presented to the user to provide another framework to create an innovative way of generating a playlist that is both fast and easy by mapping out a playlist path using the waypoints, as explained hereinafter.

Referring to FIG. 3(b), a song will be played based on a configuration of attribute values that corresponds to the specified position in the display by creating a playlist path. To create a playlist path, the user needs to specify “waypoints” or playlist points (generated by clicking certain locations on the touch-screen display) in the artist map and specify a number of songs. As shown, the waypoints are placed on the artist map, and determine the kind of music and the era that will be in the playlist. As shown in FIG. 3(b), the user could place the four waypoints and specify the number of songs (e.g., 24) to be played along this playlist path (or may use the default value). The set of waypoints (indicated by black circles) form a path that the playlist will follow.

The artist map in FIG. 3(b) features both year and tempo magnets, resulting in an artists clustering that clearly separates the groups of slow, medium and fast music. To keep the picture simple, color doesn't convey any new information here; it only accentuates the tempo groups. Thus, the four ways and the order in which they were placed creates a path that represents the playlists. In this example, the playlist starts with music of approximately medium tempo from the eighties, then gradually plays faster music while the song's year of release increases much faster from the year 2000/2001. Since the total number of songs in the playlist is set to 24, the user will see 8 songs on each of the 3 parts of the path.

It should be noted that the same way to generate playlists as explained above could be applied when there are other types of magnets on the screen. Thus, although artist maps are shown in FIGS. 2 and 3 for illustrative purposes, it is to be understood that the present invention can support different combinations of magnets representing other groupings of music. Thus, the magnets in the drawing should not impose limitations on the scope of the invention. For example, another way to create a playlist path is by specifying only one waypoint and clicking the play button. The default number of songs for one waypoint may be 0, meaning it should just keep playing until manually stopped. In this example, the songs a user can expect in this case are close to the only waypoint he or she specified. If the user wants to have as much control over the playlist path creation as possible, the user can set the number of played songs equal to the number of waypoints placed. If all waypoints are placed near or on an artist, one song from each of these artists can be added to the playlist. Furthermore, the user may see the artist map shown in FIG. 3(a), after selecting a happy-music region shown in FIG. 2, to further select a certain happy music from a different time zone. As a result, the user can precisely specify from which artists, in what sequence of time, and what kind of songs should be played.

Given an artist map shown in FIGS. 2 and 3 (or other artist maps), a number of waypoints, and a number of songs to be played, the process of building the playlists is divided into the following steps, as shown in FIG. 4: (1) Playlist point generation: (2) Artist selection algorithm; (3) Song selection algorithm; and (4) load a playlist.

(1) Playlist Point Generation:

Based on the number of songs, say n, and the given waypoints in a given collection, playlists points can be generated by dividing the playlist path into n−1 segments to provide us n different endpoints.

Based on the magnets in the artist maps, an attribute-configuration is computed (e.g. from happy-fast songs to aggressive-faster songs). The attribute-configuration defines the type of song that the user wishes to play, as indicated by the playlist points.

(2) Artist Selection Algorithm:

Algorithm 1:

$${a}^{*} = \begin{matrix}arg min \\ a\end{matrix} d ( {P}_{a} , {P}_{x} ) ,$$

where aεA={a₁, . . . aₙ} represents the set of artists in the collection;

Pₐ represents the position of artist a (is a x,y coordinate); and

Pₓ represents the position of the current playlist point

Note that chosen artist a* is the closest artist to the current playpoint.

Algorithm 2:

a*=random{a}*

{a}*={aεA:d(Pₐ,Pₓ)<ε}

Note that the artist a* is chosen randomly from a set of artists from the playlist points whose distance is smaller than a previously determined threshold E.

(3) Song Selection Algorithm:

Algorithm 1:

s*=random(S)

S={s₁, . . . s_{K}}

where S represents the set of songs performed by artist a*.

Note that a random song s* is chosen from the song performed by the selected artist.

Algorithm 2:

s*=random(S)

Sc={s₁, . . . s_{K}}

where s* represents the song performed by the selected artist that respect certain constraints imposed by the artist map, and where, Sc represents the set of songs performed by artist a* constrained by the attribute magnets close to the playpoint (e.g. only happy and fast songs).

Once the attribute configuration is obtained, an artist that matches the attribute configuration close enough and has not been played in the playlist before is selected for play, and if played before, the next closest artist is selected

(4) Load a Playlist:
During the loading of the playlist, the list can be shown on the display to communicate visually the list of music contained in the playlist. Users are able to readily identify and trace the selected music highlighted by playlist points and may advance through the loaded playlist for the duration of their use. At this point, the playlist on the screen can be selectively selected to permit a user to a desired song.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary embodiments of the invention are described in the context of music data, one skilled in the art will recognize that the present invention is not limited to the music, and that the methods of tailoring media to a user, as described in the present application, may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld-device operating systems and other application-specific operating systems are contemplated, especially as the number of wireless networked devices continue to proliferate. Therefore, the present invention should not be

1. An apparatus (100) having an on-screen display (34), comprising:
means for generating at least one playlist for presentation in a display, said playlist generated by creating a playlist path that connects at least one region on an artist map displayed on the display.

2. The apparatus of claim 1, wherein said playlist path is selectively created by manually connecting a plurality of regions in sequence on said artist map.

3. The apparatus of claim 1, wherein said artist map includes year and/or tempo magnets, resulting in an artists clustering that clearly separates the groups of slow, medium and fast music.

4. The apparatus of claim 1, wherein said artist map includes mood and/or genre magnets, resulting in an artists clustering that clearly separates the groups of slow, medium and fast music.

5. The apparatus of claim 1, wherein said artist map includes different coloring scheme to represent an overview of a large music collection in said artist map.

6. The apparatus of claim 1, wherein said artist map includes artists positioned based on the sound of their music in such a way that similar artists are placed close together.

7. The apparatus of claim 1, wherein said display (34) is a touchscreen display.

8. The apparatus of claim 1, wherein said generating means provides a continuously visible display of said selected playlist path in a period comprising the duration of said user's interactive operation of said apparatus.

9. The apparatus of claim 1, further comprising means for specifying a number of songs to be generated on said at least one playlist.

10. The apparatus of claim 1, further comprising means for selecting at least one song based on said created playlist path.

11. The apparatus of claim 10, wherein said at least one artist (a*) is selected according to the following equation:
$${a}^{*} = \begin{matrix}arg min \\ a\end{matrix} d ( {P}_{a} , {P}_{x} ) ,$$
wherein a represents all the artists in said artist map;
Pₐ represents the position of x,y coordinate on said artist map; and
Pₓ represents the position of a current playlist point of said playlist path, and wherein a* represents the closest artist to the current playlist point.

12. The apparatus of claim 10, wherein said at least one artist is selected randomly from a set of artists whose distance from a playlist point of said playlist path is smaller than a predetermined threshold value.
a*=random{a}*
{a}*={aεA:d(Pₐ,Pₓ)<ε}

13. The apparatus of claim 11, wherein at least one song per artist is selected randomly.

14. The apparatus of claim 11, wherein at least one song per artist is selected according to the following equation:
s*=random(S)
Sc={s₁, . . . s_{K}}
where Sc represents a set of songs performed by said artist a* and defined by the attribute magnets close to said playlist path.

15. An apparatus (100) having an on-screen display (34) for providing a playlist, comprising means for providing said playlist for a sequential selection of music, wherein said playlist is generated based on a configuration of attribute values that corresponds to a specified position selected by a user on an artist map within said display (34), said artist map including an overview of a large music collection based on the sound of music in such a way that similar artists are placed close together.

16. The apparatus of claim 15, further comprising means for specifying a number of songs to be generated on the playlist.

17. The apparatus of claim 15, wherein said artist map further includes different colors to reflect different tempos of music.

18. The apparatus of claim 15, wherein said display (34) is a touch-screen display.

19. A method for generating a playlist of media in accordance with a user's preferences, the method comprising the steps of:
providing an artist map on an on-screen user interface display (34);
selectively creating a playlist path that connects at least one region on said artist map; and
generating said playlist corresponding to a sequence selection of desired media based on a configuration of attribute values that corresponds to a specified position selected by said user on said artist map.

20. The method of claim 19, wherein said artist map includes an overview of a large music collection based on the sound of music in such a way that similar artists are placed close together.

21. The method of claim 19, further comprising the step of presenting said generated playlist to said user.

22. The method of claim 19, further comprising the step of selecting at least one song based on said created playlist path.

23. The method of claim 19, wherein said at least one artist (a*) is selected according to the following equation:
$${a}^{*} = \begin{matrix}arg min \\ a\end{matrix} d ( {P}_{a} , {P}_{x} ) ,$$
wherein a represents all the artists in said artist map;
Pₐ represents the position of x,y coordinate on said artist map; and
Pₓ represents the position of a current playlist point of said playlist path, and wherein a* represents the closest artist to the current playlist point.

24. The method of claim 19, wherein said at least one artist is selected randomly from a set of artists whose distance from a playlist point of said playlist path is smaller than a predetermined threshold value.
a*=random{a}*
{a}*={aεA:d(Pₐ,Pₓ)<ε}

25. The method of claim 23, wherein at least one song per artist is selected randomly.

26. The method of claim 23, wherein at least one song per artist is selected according to the following equation:
s*=random(S)
Sc={s₁, . . . s_{K}}
where Sc represents a set of songs performed by said artist a* and defined by the attribute magnets close to said playlist path.

27. A computer-readable medium bearing computer-executable instructions for carrying out the method of claim 19.

28. A system for generating at least one playlist in accordance with a users preferences, comprising:
a processor (28);
a memory (30), coupled to said processor (28), said memory (30) being configured to allow the processor (28) to:
provide an artist map having a large selection of media according to a predefined format on an on-screen user interface display (34);
generate a playlist path that connects at least one region on said artist map; and,
provide said playlist corresponding to a sequence selection of desired media based on a configuration of attribute values that corresponds to a specified position selected by said user on said artist map.

29. The system of claim 28, wherein said artist map includes an overview of a large music collection based on the sound of music in such a way that similar artists are placed close together.

30. The system of claim 28, wherein said artist map includes both year and tempo magnets, resulting in an artists clustering that clearly separates the groups of slow, medium and fast music.

31. The system of claim 28, wherein said artist map includes mood and/or genre magnets, resulting in an artists clustering that clearly separates the groups of slow, medium and fast music.

32. The system of claim 28, wherein said artist map includes different coloring scheme to represent an overview of a large music collection in said artist map.
limited to any single embodiment but rather construed in breadth and scope in accordance with the appended claims.
